(19) United States
(12) Patent Application Publication
(10) Pub. No.: US 2005/0109994 A1
(43) Pub. Date: May 26, 2005

(54) Liquid sprayable flame resistant coatings composition and method of use thereof

(76) Inventors: Robert R. Matheson, West Bloomfield, MI (US); David A. Fischer, Rochester, MI (US); David L. Cate, Katy, TX (US); Basil V. Gregorovich, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/924,397

(22) Filed: Aug. 23, 2004

Related U.S. Application Data
(60) Provisional application No. 60/497,382, filed on Aug. 22, 2003.

(51) Int. Cl. C09K 21/00

(52) U.S. Cl. 252/609

(57) ABSTRACT

A flame resistant coating composition comprising a film-forming polymeric component, a curing agent capable of curing said coating composition, and a flame resistant material component, as well as a method of use thereof, which are useful as a vehicle bed liner sprayable coating are disclosed.

### CROSS-REFERENCE TO RELATED APPLICATION

This application claims priority under 35 U.S.C. §119 from U.S. Provisional Application Ser. No. 60/497,382 (filed Aug. 22, 2003), which is incorporated by reference herein as if fully set forth.

### BACKGROUND OF THE INVENTION

This invention is directed to coating compositions, for use over transportation substrates. In particular, the present invention is directed to a liquid sprayable coatings composition useful as a flame resistant coating over light and medium duty truck beds.

Molded truck bed liners have been utilized and are comprised of a variety of materials such as polyethylene or polypropylene or polyvinyl chloride. The liners are generally vacuum formed and are stored in inventory to fit a particular configuration of truck bed in order to be a drop-in liner. Such liners have become useful as a means of protecting the truck bed itself and to improve and maintain the appearance characteristics of the vehicle.

A major problem with pre-formed drop-in place truck bed liners is inventory requirements, as substantial amounts of volumetric space must be available for storage of such liners. Further, such liners, after installation, have a tendency to crack upon exposure to extreme environmental conditions, thereby separating from the truck bed itself. Drop-in liners are also plagued with problems of dirt, moisture and mud amassing between the truck bed and the liner. This creates an environment for accelerated corrosion of the substrate beneath the liner.

Truck bed liners formed by applying a sprayable coating onto a truck bed and allowing the material to harden into tough, but resilient lining material are also well known in the art. Such coatings compositions may be single or multi-component, and thermally or ambient cured. Sprayable epoxy, polyurethane, or polyurea are examples of the chemistries used in such compositions. These coatings typically contain a curable resin as the main film-forming component, an elastomeric component, and a reinforcing filler.

Sprayable bed liners provide a number or improvements over drop-in liners, including improved corrosion and cracking resistance, while avoiding dirt, moisture, and mud packing problems. However, in order to provide such desired durability, such coatings must be applied at very high film builds. As such, they add considerable mass to the truck bed of potentially dangerous and very combustible organic material. Therefore, there is a need for coating compositions which are flame resistant.

Accordingly, it is an object of the present invention to provide a sprayable coating composition which possesses flame resistance, as well as possessing the ability to withstand the frictional and durability requirements of a truck bed. It is another object of the invention to render such composition conductive to minimize the possibility of generating static electricity that may ignite gasoline that may be stored on the truck bed or may be a hazard during the gasoline filling operation. It is also desirable that such a coating be capable of being applied using conventional spray equipment over a variety of topcoats and have excellent adhesion.

### SUMMARY OF THE INVENTION

The invention is directed to curable coating compositions useful for forming protective liners over truck beds and other substrates by spraying. The coating composition comprises:
(a) a curable film-forming polymeric material;
(b) a curing agent capable of curing said coating composition; and
(c) a flame retardant component.

Optionally, the composition may further comprise one or more of the following ingredients:
(d) a conductive material
(e) an elastomeric material; and
(f) a reinforcing filler.

Most preferably, the composition is sprayable liquid composition wherein solvents and diluents are used as the liquid carrier to disperse and/or dilute the above mentioned polymers and facilitate formulation and spray application.

This invention is also directed to a process for coating a substrate with the above coating composition and a substrate such as a vehicle body or a part thereof having adhered thereto a coating according to the above composition.

The composition of the present invention is preferably used to form a vehicle bed liner in situ by applying the composition onto the vehicle bed, preferably during vehicle assembly operations, followed by curing and forming the liner on the vehicle bed.

### DETAILED DESCRIPTION OF THE INVENTION

The terminology “flame resistance” or “flame resistant” is herein defined as not susceptible to combustion to the point of propagating a flame, after exposure to an ignition source.

The term “conductive” is herein defined as the characteristic of conducting or transmitting electrical current, and a such, should be considered the reciprocal of electrical resistivity.

The term “in situ” as used herein is defined as in place. In the context of forming a coating, “in situ” means forming in place, as contrasted with pre-forming with subsequent drop-in installation.

The composition of the present invention is useful as a coating for a transportation vehicle substrate. The coating composition of the present invention forms a tough finish, which has superior flame resistance properties, as well as durability against environmental and frictional affects. In particular, the coating composition of this invention is most useful to form a truck bed liner in place by spray applying the coating onto a truck bed, and then curing the coating.

While the coatings composition of the present invention may be in powder, slurry, or liquid form, preferably, the coating composition is in a liquid form.

The coating composition forms a cured coating that is coextensive with the shape of the substrate. Therefore, any particular product could be formed depending upon the mold shape. Almost any suitable formed substrates, whether they be metallic, wood, or plastic, could also be employed. Examples would include automobile and truck panels, aircraft panels, cargo ship substrates, shipping containers, heavy trucks, railroad stock, among many others.

The coating composition of the present invention may be formulated to yield a variety of textures dependent upon customer needs. The composition can also be custom color tinted to virtually any color. Further, the composition can be modified to exhibit varying coefficients of friction and increased tensile strength through cure modification.

The finally cured coating composition product is one that has a substantial thickness ranging from about 100 to about 15000 micrometers (about 4 to 600 mils), preferably from about 1000 to 5000 micrometers (about 40 to 200 mils).

The coatings composition of the present invention may be applied to the substrate by various techniques, such as pneumatic spray, high volume/low pressure, electrostatic rotational bell, roller, brush applicators, among many others, used in conjunction with robotic, automatic, or manual processes. Preferably, the coating is applied using high volume/low pressure applicator in conjunction with a robot arm.

The coating composition of the present invention contains a film-forming polymeric component. The polymeric component is a polymer which reacts with the curing agent, to form a film network, thus imparting durability and strength. The polymer may be included with the curing agent in a single package system, or added as a separate material in a multiple package system.

The polymer employed in this invention contains hydroxyl, amine, carboxylic acid, hydrolyzable silane, acetoacetonate or epoxy functionality. The polymer may also contain any practical combination of the aforementioned functionality's. Conventionally known polyacrylic, polyester, cellulosic, alkyd, aliphatic epoxide, polyurea, and polyurethane polymers are most useful as the polymeric component. Further, the polymeric component may be an oligomeric material. In a preferred embodiment, the polymeric component is an amine functional polyurea polymer.

The coating composition of the present invention also contains a curing agent capable of crosslinking the coating under desired curing conditions. Curing conditions include the temperature range from ambient temperature to about 150° C.

Curing agents that are employed in the present invention are aliphatic or aromatic polyisocyanate resins, conventional monomeric melamine formaldehyde resins, and conventional polymeric melamine formaldehyde resins. Examples of some useful polyisocyanate resins include the isocyanurate of hexamethylene diisocyante, biuret of hexamethylene diisocyante, isophorone diisocyante, toluene diisocyante, methylene diisocyante, and any mixtures thereof.

Catalysts may be added to the liquid coating composition to further enhance the crosslinking reaction between the polymeric material and curing agent. Typical catalysts employed are organic phosphoric acids, organic sulfonic acids, or organo-metallic complexes such as dibutyl tin dilaurate.

In order to obtain a room temperature curable coating composition, it is most desirable that the coating composition be a two, or multiple component composition. By that it is meant that the polymeric material is placed in one container and the curing agent is placed in a second container. The curing of the coating starts when the materials are blended just prior to the spraying process. Such multiple component compositions are also very useful in low bake conditions, in which the curing temperature ranges from about 40 to about 95° C. In a preferred embodiment, an aliphatic polyisocyanate resin is used as the curing agent, in combination with an organometallic catalyst.

Single component high temperature curable compositions may be formulated in the present invention. Such composition are curable in the temperature range from about 80 to about 150° C. Polymeric or monomer melamine-formaldehyde resins are most useful as curing agents. These curing agents are typically used in conjunction with an organic sulfonic or phosphoric acid catalyst.

The coating composition of the present invention contains a flame retardant component. Any commercially available flammable resistant material which is practically and effectively usable in any coatings composition of the present invention may be used. U.S. Pat. No. 6,015,510 Jacobson, et. al., and U.S. Pat. No. 5,998,503 Jacobson, et. al., herein incorporated by reference, disclose flame retardant polymers which may be particularly useful flammable resistant materials. Also commercially available flammable resistant based upon halogenated phosphates or halogen free phosphates are useful as well.

The coating composition may optionally contain a conductive agent. Any commercially available conductive agent which may be practically incorporated into the composition may be used. Examples of conducting agents are any of the various carbon blacks, powdered graphite, powdered or flake metals such as zinc, iron, copper, brass, bronze, stainless steel, nickel, silver, gold, aluminum, or even molybdenum disulfide, iron phosphide, BaSO₄ doped with tin or antimony, and the like. The conductive agent may be chosen to meet the specific end-use criteria, by those skilled in the art.

Additional materials may be used in the liquid coating composition such as reactive or non-reactive materials which can assist in increasing tensile strength, impact resistance, hardness and rigidity, increasing film build, decreasing shrinkage, decreasing coefficient of thermal expansion, increasing thermal conductivity, reducing moisture penetration, increasing flow, and decreasing flow. Examples of some materials that may be employed are silica's, silicates, calcium carbonates, clays, iron oxides, aluminum oxides, portland cement, fibrous materials, blowing agents, natural or synthetic rubber compounds, elastomeric materials, anti-static agents, mold release agents and other lubricants, antioxidants, thermal stabilizers, ionomers such as those commercially available under the tradename Surlyn® from E. I. du Pont de Nemours and Company, aramid materials such as those available under the tradenames Kevlar® or Nomex®from E. I. du Pont de Nemours and Company, fluoropolymer resins available under the tradename Teflon® from E. I. du Pont de Nemours and Company, recycled tires, paint waste sludge, and the like. Pigments may be added for coloring purposes, hiding, and/or rusting inhibition.

Further, if desired, a suitable solvent or diluent, or blend of solvents, to control the viscosity for the spraying purposes may be incorporated. Examples of suitable solvents include, but are not limited to, methanol, n-butanol, methyl isobutyl ketone, diisobutyl ketone, methyl ethyl ketone, methyl amyl ketone, toluene, xylene, acetone, ethylene glycol monobutyl ether acetate, n-butyl acetate, t-butyl acetate, n-propyl propionate, n-butyl propionate, n-propyl acetate, as well as other ester, ethers, ketone, aliphatic and aromatic hydrocarbon solvents that are conventionally used.

To further enhance durability, ultraviolet light stabilizers or a combination of ultraviolet light stabilizers may be added to the clear coat composition. Such stabilizers include ultraviolet light absorbers, screeners, quenchers, and hindered amine light stabilizers. Typical ultraviolet light stabilizers that are useful include benzophenones, triazoles, triazines, benzoates, hindered amines and mixtures thereof. Specific examples of ultraviolet stabilizers are disclosed in U.S. Pat. No. 4,591,533, the entire disclosure of which is incorporated herein by reference. For good durability, a blend of Tinuvin® 1130, Tinuvin® 384 and Tinuvin® 123 (hindered amine light Stablizer), all commercially available from Ciba-Geigy, is preferred. Also, an antioxidant can be added. The use of such ultraviolet light stabilizers allows for the long term durability and adhesion of the coating composition to conventional primer surfacers and electrocoat primers.

Various modifications, alterations, additions or substitutions of the components of the compositions of this invention will be apparent to those skilled in the art without departing from the spirit and scope of this invention. This invention is not limited by the illustrative embodiments set forth herein, but rather is defined by the following claims.

1. A curable coating composition useful for forming a vehicle bed liner comprising:
(a) a polymeric component;
(b) a curing agent capable of curing said coating composition; and
(c) a flame resistant component.

2. A method of forming a vehicle bed liner in situ comprising the steps:
(a) providing a coating composition comprising a polymeric component, an effective reinforcement material, amount of a fiber, a curing agent capable of curing said coating composition;
(b) applying the composition onto a vehicle bed; and
(c) curing and forming the liner on said vehicle bed.

3. The method of claim 2 wherein said bed is a truck bed.

4. The coating composition of claim 1 which further comprises a conductive agent.

5. The coating composition of claim 1 wherein the composition is a sprayable liquid composition.
